(19) United States
(12) Patent Application Publication
(10) Pub. No.: US 2026/0303979 A1
(43) Pub. Date: Oct. 1, 2026

(54) CAPTURE METHOD, TERMINAL DEVICE, AND NON-TRANSITORY COMPUTER-READABLE STORAGE MEDIUM

(71) Applicant: Beijing Zitiao Network Technology Co., Ltd., Beijing (CN)

(72) Inventor: Mingyi LI, Beijing (CN)

(21) Appl. No.: 19/561,412

(22) Filed: Mar. 9, 2026

(30) Foreign Application Priority Data
Mar. 31, 2025 (CN) 202510398773.8

(51) Int. Cl. H04N 23/73; H04N 23/667

(52) U.S. Cl. CPC H04N 23/73; H04N 23/667

(57) ABSTRACT

The present disclosure provides a capture method, a terminal device, and a non-transitory computer-readable storage medium. The capture method includes: determining a camera capture mode in response to a touch on a first control; determining a first exposure parameter and a first parameter of the camera based on the camera capture mode, the first parameter being a first sensitivity or a first exposure duration; and determining a second exposure parameter of the camera based on the first exposure parameter and the first parameter, the camera performing capture based on the second exposure parameter.

### CROSS-REFERENCE TO RELATED APPLICATION

This application claims the priority to and benefits of the Chinese Patent Application No. 202510398773.8, which was filed on Mar. 31, 2025. The aforementioned patent application is incorporated herein by reference in its entirety.

### TECHNICAL FIELD

The present disclosure relates to the field of multimedia technologies, and in particular, to a capture method, a terminal device, and a non-transitory computer-readable storage medium.

### BACKGROUND

A camera may include a preview stream and a photo-taking stream, the preview stream may be used for on-screen preview, and the photo-taking stream may be used for outputting images captured by a user.

At present, the camera analyzes images in the preview stream and determines a set of exposure parameters. When the user takes a photo, the camera may capture an image with appropriate brightness based on the set of exposure parameters. The inventors have found that in the traditional method for determining exposure parameters, although the accuracy of image brightness is high, in some scenarios, the image may have noise and blurring, resulting in low accuracy of the capture.

### SUMMARY

At least an embodiment of the present disclosure provides a capture method, including:
determining a mode in which a camera photographs in response to a touch on a first control;
determining a first exposure parameter and a first parameter of the camera based on the camera capture mode, the first parameter being a first sensitivity or a first exposure duration; and
determining a second exposure parameter of the camera based on the first exposure parameter and the first parameter, the camera performing capture based on the second exposure parameter.

At least an embodiment of the present disclosure provides a capture apparatus, including a first determination module, a second determination module, and a third determination module, where:
the first determination module is configured to determine a mode in which a camera photographs in response to a touch on a first control;
the second determination module is configured to determine a first exposure parameter and a first parameter of the camera based on the camera capture mode, the first parameter being a first sensitivity or a first exposure duration; and
the third determination module is configured to determine a second exposure parameter of the camera based on the first exposure parameter and the first parameter, the camera performing capture based on the second exposure parameter.

At least an embodiment of the present disclosure provides a terminal device, including: at least a processor and a memory;
the memory stores a computer-executed instruction; and
the processor executes the computer-executed instruction stored in the memory, so as to cause the at least one processor to execute the above capture method and various possible involvements of thereof.

At least an embodiment of the present disclosure provides a non-transitory computer-readable storage medium, where a computer-executed instruction is stored in the computer-readable storage medium, and when the computer-executed instruction is executed by a processor, the above capture method and various possible involvements thereof is implemented.

At least an embodiment of the present disclosure provides a computer program product, including a computer program, where when the computer program is executed by a processor, the above capture method and various possible involvements thereof.

### BRIEF DESCRIPTION OF DRAWINGS

In order to more clearly describe the technical solutions in at least an embodiment of the present disclosure, the following will briefly introduce the drawings that need to be used in the description of the embodiments or the prior art. Obviously, the drawings in the following description are some embodiments of the present disclosure. For those of ordinary skill in the art, other drawings may be obtained based on these drawings without creative efforts.

FIG. 1 is a schematic diagram of an application scenario according to at least an embodiment of the present disclosure;

FIG. 2 is a schematic flowchart of a capture method according to at least an embodiment of the present disclosure;

FIG. 3 is a schematic diagram of a process of determining a first parameter according to at least an embodiment of the present disclosure;

FIG. 4 is a schematic diagram of another process of determining a first parameter according to at least an embodiment of the present disclosure;

FIG. 5 is a schematic diagram of a method for determining a second exposure parameter according to at least an embodiment of the present disclosure;

FIG. 6 is a schematic diagram of another method for determining a second exposure parameter according to at least an embodiment of the present disclosure;

FIG. 7 is a schematic structural diagram of a capture apparatus according to at least an embodiment of the present disclosure; and

FIG. 8 is a schematic structural diagram of a terminal device according to at least an embodiment of the present disclosure.

### DETAILED DESCRIPTION

Here, the exemplary embodiments will be described in detail, and examples thereof are represented in the drawings. When the following description refers to the drawings, unless otherwise indicated, the same numbers in different drawings represent the same or similar elements. The implementations described in the following exemplary embodiments do not represent all implementations consistent with the present disclosure. On the contrary, they are only examples of apparatus and methods consistent with some aspects of the present disclosure as detailed in the appended claims.

It may be understood that before using the technical solutions disclosed in the embodiments of the present disclosure, the user shall be informed of the type, range of use, use scenarios, etc. of personal information involved in the present disclosure and obtain the authorization of the user in an appropriate manner in accordance with relevant laws and regulations.

For example, in response to receiving an active request from a user, a prompt message is sent to the user to clearly prompt the user that the requested operation will require access to and use of the user's personal information. In this way, the user may independently choose whether to provide personal information to software or hardware, such as a terminal device, an application, a server, or a storage medium, that performs the operations of the technical solutions of the present disclosure based on the prompt information.

As an optional but non-limiting implementation, in response to receiving an active request from a user, the prompt message may be sent to the user in the form of, for example, a pop-up window, and the prompt message may be presented in the pop-up window in text. In addition, the pop-up window may also include a selection control for the user to select “agree” or “disagree” to provide personal information to the terminal device.

It may be understood that the above process of notifying and obtaining user authorization is only illustrative and does not limit the implementations of the present disclosure, and other methods that satisfy relevant laws and regulations may also be applied to the implementations of the present disclosure.

For ease of understanding, the following explains concepts involved in the embodiments of the present disclosure.

Terminal device is a device with wireless transceiver function. The terminal device may be deployed on land, including indoors or outdoors, handheld, wearable or vehicle-mounted. The terminal device may be a mobile phone, a tablet computer, a computer with wireless transceiver function, a virtual reality (virtual reality, VR) terminal device, an augmented reality (augmented reality, AR) terminal device, a wireless terminal in industrial control, a vehicle-mounted terminal device, a wireless terminal in self driving, a wireless terminal device in remote medical, a wireless terminal device in smart grid, a wireless terminal device in transportation safety, a wireless terminal device in smart city, a wireless terminal device in smart home, a wearable terminal device, etc. The terminal device involved in the embodiments of the present disclosure may also be called a terminal, a user equipment (user equipment, UE), an access terminal device, a vehicle-mounted terminal, an industrial control terminal, a UE unit, a UE station, a mobile station, a mobile station, a far station, a remote terminal device, a mobile device, a UE terminal device, a wireless communication device, a UE agent or a UE apparatus, etc. The terminal device may also be fixed or mobile.

The following describes the application scenario of the embodiments of the present disclosure with reference to FIG. 1.

FIG. 1 is a schematic diagram of an application scenario according to an embodiment of the present disclosure. FIG. 1 shows terminal device. An interface displayed by the terminal device is a capture interface, and the capture interface includes a captured image, a night mode, a portrait mode, and a capture control. When a user selects the night mode and clicks on the capture control, the terminal device may analyze content in the image and determine a set of exposure parameters based on an analysis result, a camera may capture an image based on the exposure parameters, and the terminal device may display the image captured by the camera. The set of exposure parameters may ensure that the camera may also capture an image with high brightness at night, thereby improving the capture effect.

It should be noted that FIG. 1 is only an example of the application scenario of the embodiments of the present disclosure, and is not a limitation on the application scenario of the embodiments of the present disclosure.

A camera may include a preview stream and a photo-taking stream, where the preview stream may be used for on-screen preview, and therefore, the preview stream needs to ensure fluency and low latency, and the photo-taking stream is used for outputting an image captured by a user, and therefore, the capture stream needs precise control of image quality and exposure. At present, the camera may automatically determine a set of exposure parameters and capture an image based on the exposure parameters. For example, the camera may analyze an image in the preview stream and determine an aperture, a sensitivity, and an exposure duration according to the analysis result, and the camera may capture an image based on the aperture, the sensitivity, and the exposure duration, so that the accuracy of brightness of the image is high.

However, in some scenes, the image may have noise and blurriness. For example, in a scene of night capture, in order to improve the brightness of the image, the sensitivity in the exposure parameters determined by the camera is relatively high, but the sensitivity of the camera in this scenario is relatively sensitive, and noise may appear in the captured image when the sensitivity is relatively high. For example, in a scenario of sports capture, in order to improve the brightness of the image, the exposure duration in the exposure parameters determined by the camera may be relatively long, but the exposure duration of the camera in this scenario is relatively sensitive, and blurring may occur in the captured image when the exposure duration is relatively long. In this way, the accuracy of capturing by the camera is relatively low, and it takes a long time for the camera to analyze the image of the preview stream, resulting in low efficiency of capturing by the camera. Moreover, when the user manually modifies the exposure parameters, the user needs to have a high level of expertise, and the user also needs to adjust the exposure parameters multiple times, thereby increasing the difficulty of capturing by the user.

At least an embodiment of the present disclosure provides a capture method. In response to a touch on a first control, a terminal device may determine a camera capture mode, and based on the camera capture mode, determines a first exposure parameter and a first parameter of the camera. The terminal device may determine a second parameter based on the first exposure parameter and determine a second exposure parameter based on the first exposure parameter, the first parameter, and the second parameter. And the camera may perform capturing based on the second exposure parameter. In the above method, the accuracy of an exposure value indicated by the second parameter is high, and in the case where the exposure value of the camera is determined, the terminal device may re-determine a set of second exposure parameters in combination with the mode of the camera and the current first exposure parameter.

The technical solutions of the present disclosure and how the technical solutions of the present disclosure solve the above technical problems are described in detail below with specific embodiments. The following specific embodiments may be combined with each other, and the same or similar concepts or processes may not be repeated in some embodiments. The embodiments of the present disclosure will be described below with reference to the drawings.

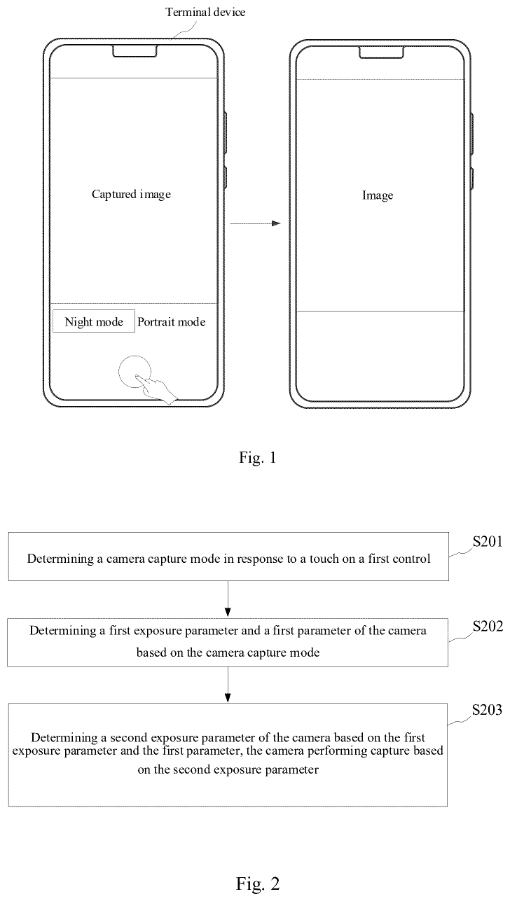

FIG. 2 is a schematic flowchart of a capture method according to at least an embodiment of the present disclosure. Referring to FIG. 2, the method may include the following steps.

In S201, determine a camera capture mode in response to a touch on a first control.

An execution body of the embodiments of the present disclosure may be a terminal device, or may be a capture apparatus in the terminal device. The capture apparatus may be implemented based on software, and may also be implemented based on a combination of software and hardware, which is not limited in the embodiments of the present disclosure.

In some embodiments, the first control may be associated with the camera capture mode. For example, in the embodiment shown in FIG. 1, the first control may be a control of the night mode, and the first control may also be a control of the portrait mode, in other words, when the first control is the control of the night mode, in response to that the user clicks on the first control, the terminal device may determine that the camera capture mode is the night mode, and when the first control is the control of the portrait mode, in response to that the user clicks on the first control, the terminal device may determine that the camera capture mode is the portrait mode.

In some embodiments, the camera capture mode may include any mode such as a night mode, a portrait mode, a sports mode, etc., which is not limited in the embodiments of the present disclosure.

In some embodiments, a capture interface of the camera may include the first control. For example, the terminal device may display a camera interface based on an operation of the user, and the camera interface may include the first control. For example, when the user clicks on an icon of an application, the terminal device may launch the application and display a home interface of the application, the home interface may include a second control, and when the user clicks on the second control, the capture interface of the camera may be displayed in an interface of the application, and the capture interface may include the first control associated with the camera capture mode.

In S202, determine a first exposure parameter and a first parameter of the camera based on the camera capture mode.

The exposure parameter of the camera may be used to control brightness and picture effect of an image. The exposure parameter of the camera may include an aperture, an exposure duration (shutter speed), and a sensitivity.

The aperture may be used to control a size of an opening of a lens. For example, when the aperture is relatively large, the lens allows more light to enter, resulting in a blurred background, which is suitable for portrait photos and close-up shots, and when the aperture is relatively small, the lens allows less light to enter, resulting in a clear image, which is suitable for landscape photos, group photos, etc.

The exposure duration may be used to control a duration of light entering. For example, when the exposure duration is relatively short, that is, the shutter speed is relatively fast (e.g., high-speed shutter), the lens allows less light to enter, which is suitable for capturing an image of a dynamic object, and when the exposure duration is relatively long, that is, the shutter speed is relatively slow (slow shutter), the lens allows more light to enter, which is suitable for capturing an image of a static object.

The sensitivity is used to control a light sensitivity of a camera's sensor. For example, when the sensitivity is relatively low, the sensor has low light sensitivity, therefore, the images captured by the camera has better details, which is suitable for capturing in a bright environment. When the sensitivity is relatively high, the sensor has high light sensitivity, therefore, the images captured by the camera has higher brightness, which is suitable for capturing in indoor environments and night scene, and the like.

In some embodiments, the first exposure parameter may be a current exposure parameter of the camera, may be an exposure parameter determined by the camera last time, may be an average exposure parameter of the camera within a period of time, or may be an exposure parameter of a future period of time predicted by the camera based on a current image, which is not limited in the embodiments of the present disclosure.

In some embodiments, the terminal device may determine the first exposure parameter of the camera based on a following feasible implementation: acquiring a first aperture, a third sensitivity, and a third exposure duration associated with the camera capture mode, and determining the first aperture, the third sensitivity, and the third exposure duration as the first exposure parameter. In this way, the terminal device may determine a set of exposure parameters with relatively accurate brightness, and adjust the sensitivity or the exposure duration of the camera based on the set of exposure parameters and the current scenario, thereby avoiding noise and blurriness in the image, and improving the accuracy of capturing by the camera.

In some embodiments, the first aperture may be an aperture currently determined by the terminal device, the third sensitivity may be a sensitivity currently determined by the terminal device, and the third exposure duration may be an exposure duration currently determined by the terminal device. For example, after the user selects the camera capture mode, a screen of the terminal device may display an image of the preview stream output by the camera, and the terminal device may automatically determine a set of exposure parameters based on the image in the preview stream, the set of exposure parameters may be the first exposure parameter, an aperture in the set of exposure parameters may be the first aperture, a sensitivity in the set of exposure parameters may be the third sensitivity, and an exposure duration in the set of exposure parameters may be the third exposure duration. For example, the terminal device may analyze the image in the preview stream and determine a set of first exposure parameters based on the analysis result. It should be noted that the terminal device may analyze the image in the preview stream based on any feasible implementation, which is not limited in the embodiments of the present disclosure.

In some embodiments, the terminal device may also determine a correspondence between the camera capture mode and the aperture, the sensitivity, and the exposure duration, and the terminal device may determine the first aperture, the third sensitivity, and the third exposure duration based on the correspondence and the mode selected by the user. For example, the correspondence between the camera capture mode and the aperture, the sensitivity, and the third exposure duration may be shown in Table 1:

TABLE 1

| Camera capture mode | Aperture | Sensitivity | Exposure duration |
|---|---|---|---|
| Portrait mode | Aperture 1 | Sensitivity a | Exposure duration A |
| Night scene mode | Aperture 2 | Sensitivity b | Exposure duration B |
| Sports mode | Aperture 3 | Sensitivity c | Exposure duration C |

It should be noted that Table 1 is only an example of the correspondence between the camera capture mode and the aperture, the sensitivity, and the third exposure duration, and is not a limitation on the correspondence between the camera capture mode and the aperture, the sensitivity, and the third exposure duration.

As shown in Table 1, when the camera capture mode selected by the user is the portrait mode, the terminal device may determine the first aperture in the first exposure parameter as aperture 1, the third sensitivity as sensitivity a, and the third exposure duration as exposure duration A; when the camera capture mode selected by the user is the night scene mode, the terminal device may determine the first aperture in the first exposure parameter as aperture 2, the third sensitivity as sensitivity b, and the third exposure duration as exposure duration B; and when the camera capture mode selected by the user is the sports mode, the terminal device may determine the first aperture in the first exposure parameter as aperture 3, the third sensitivity as sensitivity c, and the third exposure duration as exposure duration C.

In some embodiments, the camera capture mode may correspond to an aperture range, a sensitivity range, and a third exposure duration range. For example, the correspondence between the camera capture mode and the aperture range, the sensitivity range, and the third exposure duration range may be shown in Table 2:

TABLE 2

| Camera | | | |
|---|---|---|---|
| capture mode | Aperture | Sensitivity | Exposure duration |
| Portrait mode | Aperture 1 to | Sensitivity a to | Exposure duration A to |
| | Aperture 2 | Sensitivity b | Exposure duration B |
| Night scene mode | Aperture 3 to | Sensitivity c to | Exposure duration C to |
| | Aperture 4 | Sensitivity d | Exposure duration D |
| Sports mode | Aperture 5 to | Sensitivity e to | Exposure duration E to |
| | Aperture 6 | Sensitivity f | Exposure duration F |

It should be noted that Table 2 is only an example of the correspondence between the camera capture mode and the aperture range, the sensitivity range, and the third exposure duration range, and is not a limitation thereon.

As shown in Table 2, when the camera capture mode selected by the user is the portrait mode, the terminal device determines that the first aperture in the first exposure parameter is in a range of aperture 1 to aperture 2, the third sensitivity is in a range of sensitivity a to sensitivity b, and the third exposure duration is in a range of exposure duration A to exposure duration B; when the camera capture mode selected by the user is the night scene mode, the terminal device determines that the first aperture in the first exposure parameter determined is in a range of aperture 3 to aperture 4, the third sensitivity is in a range of sensitivity c to sensitivity d, and the third exposure duration is in a range of exposure duration C to exposure duration D; and when the camera capture mode selected by the user is the sports mode, the terminal device determines that the first aperture in the first exposure parameter determined is in a range of aperture 5 to aperture 6, the third sensitivity is in a range of sensitivity e to sensitivity f, and the third exposure duration is in a range of exposure duration E to exposure duration F.

In some embodiments, the terminal device may determine any sensitivity level in the sensitivity range corresponding to the camera capture mode as the third sensitivity. For example, the night scene mode corresponds to 100 sensitivity levels, and the terminal device may determine the 1st sensitivity level as the third sensitivity, may determine the 25th sensitivity level as the third sensitivity, may determine the 50th or 51st sensitivity level as the third sensitivity, may determine the 75th sensitivity level as the third sensitivity, may determine the 100th sensitivity level as the third sensitivity, or may determine any sensitivity level as the third sensitivity, which is not limited in the embodiments of the present disclosure.

It should be noted that a method for determining the first aperture by the terminal device within the aperture range corresponding to the camera capture mode and a method for determining the third exposure duration by the terminal device within the exposure duration range corresponding to the camera capture mode are the same as the method for determining the third sensitivity by the terminal device within the sensitivity range corresponding to the camera capture mode, which will not be repeated in the embodiments of the present disclosure.

In some embodiments, after the terminal device determines the first exposure parameter based on the content shown in Table 1 or Table 2, because the first exposure parameter is determined based on the camera capture mode, there may be a relatively small difference from the current capture environment and capture scenario, therefore, the terminal device may also adjust the first exposure parameter in combination with the image in the preview stream. For example, after determining the first aperture, the third sensitivity, and the third exposure duration based on the content shown in Table 1 or Table 2, the terminal device may also analyze image content in the preview stream and adjust the first aperture, the third sensitivity, and the third exposure duration based on the analysis result (e.g., increasing the level of the third sensitivity when an area of the image has low brightness), thereby improving the accuracy of the first aperture, the third sensitivity, and the third exposure duration.

The first parameter may be used to control an exposure parameter of the camera. For example, the first parameter may be an exposure parameter for the camera to capture, and it should be noted that the first exposure parameter is an exposure parameter for the camera to output the preview stream, and because the preview stream needs to be rendered on a screen, the camera needs to ensure the fluency of the preview stream, while the camera needs to ensure the clarity of the image when outputting the capture stream, therefore, when the camera captures the image, the exposure parameter used by the camera may include the re-determined first parameter, so that the camera may acquire the preview stream and the capture stream based on different exposure parameters, thereby improving the accuracy of capturing by the terminal device.

In some embodiments, the first parameter may be a first sensitivity or a first exposure duration. For example, the first sensitivity may be a sensitivity matching the camera capture mode, and the first exposure duration may be an exposure duration matching the camera capture mode.

In some embodiments, the camera capture mode may include a first-type mode and a second-type mode. The first-type mode may be a sensitivity priority mode. For example, After the user selects a camera capture mode, the terminal device may determine that the camera capture mode is the first-type mode when the light in the capture environment is relatively weak. For example, when the camera capture mode selected by the user (e.g., the night mode) is used for capturing in an environment with relatively weak light, the terminal device may determine that the camera capture mode is the first-type mode.

The second-type mode may be an exposure duration priority mode. For example, after the user selects a camera capture mode, when there is a rapidly moving object in the image captured by the camera, the terminal device may determine that the camera capture mode is the second-type mode. For example, when the camera capture mode selected by the user (e.g., the sports mode) is used for capturing a rapidly moving object, the terminal device may determine that the camera capture mode is the second-type mode.

In some embodiments, the terminal device may determine the first parameter of the camera based on a following feasible implementation: when the camera capture mode is the first-type mode, the terminal device may determine that the first parameter of the camera is one or more first sensitivities, and when the camera capture mode is the second-type mode, the terminal device may determine that the first parameter of the camera is one or more first exposure durations. In this way, the terminal device may accurately determine the first parameter based on the type of the camera capture mode, thereby avoiding noise and blurriness in the captured image, and improving the accuracy of capturing by the camera.

Exemplarily, when the user clicks on the night scene mode, it indicates that the user captures an image in an environment with weak light, and when the terminal device automatically determines an exposure parameter, a sensitivity in the determined exposure parameter is relatively high in order to improve the brightness of the image, resulting in noise in the image. Therefore, the night scene mode may be the first-type mode, and the terminal device may quickly determine the first sensitivity by combining the night scene mode and perform capture based on the first sensitivity. Therefore, it may avoid a situation in which the first sensitivity is too high, resulting in noise in the image, and improve the accuracy of capturing by the camera.

Exemplarily, when the user clicks on the sports mode, it indicates that the user is capturing a quickly moving object, and when the terminal device automatically determines an exposure parameter and sets a relatively long exposure duration to improve the image brightness, resulting in the object in the image being relatively blurred. Therefore, the sports mode may be the second-type mode, and the terminal device may quickly determine the first exposure duration by combining the sports mode and perform capture based on the first exposure duration. Therefore, it may avoid a situation in which the first exposure duration is too long to result in blurriness of the object in the image, and improve the accuracy of capturing by the camera.

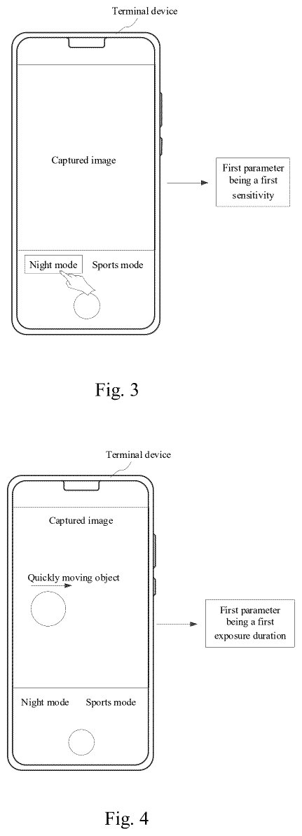

A process of determining the first parameter of the camera is described below with reference to FIGS. 3 and 4.

FIG. 3 is a schematic diagram of a process of determining a first parameter according to an embodiment of the present disclosure. Referring to FIG. 3, a terminal device is included. An interface displayed by the terminal device is a capture interface of a camera. The capture interface includes a captured image, a control of a night mode, a control of a sports mode, and a capture control. When the user clicks on the control of the night mode, the camera capture mode is set to the night mode, and the terminal device may determine that light in the current capture scenario is relatively weak and determine that the current mode is a first-type mode, that is, sensitivity is prioritized in the current mode, and the terminal device may determine that the first parameter is a first sensitivity.

It should be noted that, in the embodiment shown in FIG. 3, in response to that the user clicks on the control of the sports mode, the terminal device may determine that exposure duration is prioritized in the current mode, therefore, the terminal device may determine that the first parameter is a first exposure duration.

FIG. 4 is a schematic diagram of another process of determining a first parameter according to an embodiment of the present disclosure. Referring to FIG. 4, a terminal device is included. An interface displayed by the terminal device is a capture interface of a camera. The capture interface includes a captured image, a control of a night mode, a control of a sports mode, and a capture control. The captured image includes a circular object, and the circular object is quickly rolling to the right. Because the captured image includes a quickly moving object, the terminal device may determine the current mode as a second-type mode, that is, exposure duration is prioritized in the current mode, and the terminal device may determine that the first parameter is a first exposure duration.

It should be noted that, in the embodiment shown in FIG. 4, in response to that the user clicks on the control of the night mode, the terminal device may determine that sensitivity is prioritized in the current mode. Therefore, the terminal device may determine that the first parameter is a first sensitivity.

In some embodiments, when the camera capture mode is the first-type mode, the terminal device may determine a first sensitivity and perform capture based on the first sensitivity. When the camera capture mode is the first-type mode, the terminal device may determine a plurality of first sensitivities, in other words, the first-type mode is associated with a sensitivity range, and the sensitivities within the range may be the first sensitivities, and the terminal device may determine a first sensitivity for capturing among the plurality of first sensitivities.

Exemplarily, a value of the first sensitivity associated with the first-type mode is 450, and the terminal device may capture based on the first sensitivity. The value of the first sensitivity associated with the first-type mode is in a range of from 50 to 800, and the terminal device may determine a first sensitivity within the range of from 50 to 800 and perform capture based on the first sensitivity.

In some embodiments, when the camera capture mode is the second-type mode, the terminal device may determine a first exposure duration and perform capture based on the first exposure duration. When the camera capture mode is the second-type mode, the terminal device may determine a plurality of first exposure durations, in other words, the second-type mode is associated with an exposure duration range, and the exposure durations within the range may be the first exposure durations, and the terminal device may determine a first exposure duration for capturing among the plurality of first exposure durations.

Exemplarily, a value of the first exposure duration associated with the second-type mode is 1/100 second, and the terminal device may perform capture based on the first exposure duration. The value of the first exposure duration associated with the second-type mode is in a range of from 1/4000 second to 1/60 second, and the terminal device may determine a first exposure duration within the range of from 1/4000 second to 1/60 second and perform capture based on the first exposure duration.

In S203, determine a second exposure parameter of the camera based on the first exposure parameter and the first parameter, performing capture by the camera based on the second exposure parameter.

In some embodiments, the second exposure parameter may be an exposure parameter for the camera to perform capture. For example, the second exposure parameter may be an exposure parameter used by the camera when outputting the capture stream, in other words, when the user clicks on the capture control, the camera may perform capture based on the second exposure parameter.

The terminal device may determine the second exposure parameter of the camera based on a following feasible implementation: determining a second parameter of the camera based on the first exposure parameter and determining the second exposure parameter based on the first exposure parameter, the first parameter, and the second parameter. Because the image brightness associated with the first exposure parameter has high accuracy, and the first parameter may avoid noise and blurriness in the image, the accuracy and usability of the second exposure parameter are high, and the image captured by the terminal device has high brightness, and no noise and blurriness will appear.

In some embodiments, the second parameter may be used to indicate an exposure value of the camera. For example, the second parameter may indicate the brightness of the image captured by the camera. For example, the second parameter may be a quantified value, and the quantified value may indicate the brightness of the image captured by the camera when performing capture based on the first exposure parameter.

In some embodiments, the first exposure parameter includes the first aperture, the third sensitivity, and the third exposure duration, and the second parameter satisfies a following formula:

$$EV = ln ( \frac{100 \times {Aperture}^{2}}{ISO \times Exposure Time} ) / ln ( 2. )$$

where, in the formula, EV may be the second parameter, Aperture may be the first aperture, ISO may be the third sensitivity, and Exposure Time may be the third exposure duration.

In some embodiments, after the terminal device determines the second exposure parameter, the camera may perform capture based on the second exposure parameter, so that the image captured by the camera has high brightness, and the captured image will not have noise and blurriness, thereby improving the accuracy of capturing and improving the effect of image display.

An embodiment of the present disclosure provides a capture method. In response to a touch on a first control, a terminal device may determine a cameral capture and acquire a first aperture, a third sensitivity, and a third exposure duration associated with the camera capture mode, the terminal device may determine the first aperture, the third sensitivity, and the third exposure duration as a first exposure parameter, and determine that a first parameter of the camera is one or more first sensitivities when the camera capture mode is a first-type mode, and determine that the first parameter of the camera is one or more first exposure durations when the camera capture mode is a second-type mode, the terminal device may determine, based on the first exposure parameter, a second parameter used to indicate an exposure value of the camera and determine a second exposure parameter based on the first exposure parameter, the first parameter, and the second parameter, and the camera may perform capture based on the second exposure parameter. In this way, the brightness of an image captured by the terminal device may be the same as the brightness of a preview stream, and no noise and blurriness will appear in the image, thereby improving the accuracy of capturing. Moreover, in the above method, there is no need to analyze the image, therefore, the efficiency of capturing by the camera may be improved, and the above method also eliminates the need for the user to determine a set of exposure parameters suitable for capturing based on experience, therefore, the complexity of capturing by the camera may be reduced, and the user experience may be improved.

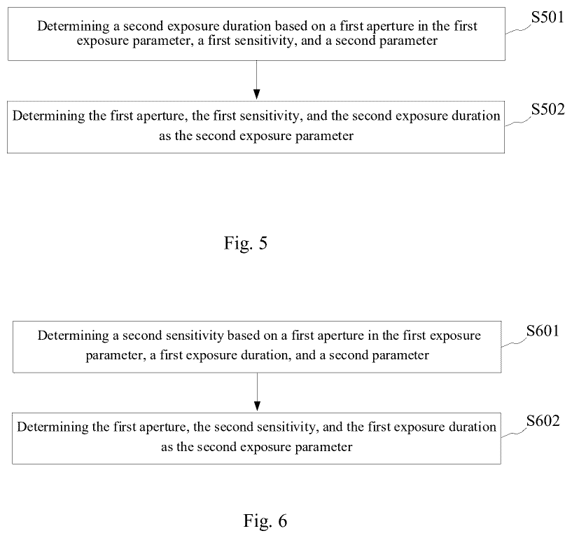

Based on the embodiment shown in FIG. 2, the first parameter may be the first sensitivity or the first exposure duration. A method for determining the second exposure parameter by the terminal device based on the first exposure parameter, the first parameter, and the second parameter in the above capture method is described in detail below with reference to FIG. 5 and FIG. 6.

FIG. 5 is a schematic diagram of a method for determining a second exposure parameter according to an embodiment of the present disclosure. In the embodiment shown in FIG. 5, the first parameter may be the first sensitivity. Referring to FIG. 5, the method flow includes the following steps.

In S501, determine a second exposure duration based on the first aperture in the first exposure parameter, the first sensitivity, and the second parameter.

The second exposure duration may be an exposure duration matching the camera capture mode. For example, when the first parameter is the first sensitivity, the exposure duration used by the camera when capturing an image may be the second exposure duration. For example, because the exposure parameter may include an aperture, a sensitivity, and an exposure duration, when determining the second exposure parameter, the terminal device has already determined the first aperture and the first sensitivity. Therefore, the terminal device may obtain the second exposure parameter after determining the second exposure duration. In other words, the first aperture and the first sensitivity are values that have been determined in the second exposure parameter, and the terminal device also needs to determine the second exposure duration in the second exposure parameter.

Optionally, because the first aperture is the aperture in the first exposure parameter, and the exposure value corresponding to the first exposure parameter has high accuracy, when determining the second exposure parameter, the terminal device may determine that the aperture in the second exposure parameter is also the first aperture in the first exposure parameter, which may ensure the brightness of the captured image.

In some embodiments, when the camera capture mode is the first-type mode, the first parameter determined by the terminal device may be the first sensitivity. Because the terminal device may determine a first sensitivity or a plurality of first sensitivities, there are following two cases in which the terminal device determines the second exposure duration based on the first aperture, the first sensitivity, and the second parameter.

In Case 1, the number of the first sensitivity is 1.

When the number of the first sensitivity is 1, the terminal device may determine the second exposure duration based on the first aperture, the first sensitivity, and the second parameter.

In some embodiments, because the number of the first sensitivity is 1, the terminal device does not need to select the first sensitivity, and the terminal device may determine the second exposure duration based on the first sensitivity, the first aperture, and the second parameter, where the second exposure duration satisfies a following formula:

$$ISO = {e}^{ln ( 100 \times {Aperture}^{2} ) - EV \times ln ( 2. ) - ln ( Exposure Time )}$$

where, in the formula, Exposure Time may be the second exposure duration, e is a natural constant, Aperture may be the first aperture, ISO may be the first sensitivity, and EV may be the second parameter.

In this way, after the terminal device determines the second exposure duration based on the above formula, the second exposure parameter composed of the first aperture, the first sensitivity, and the second exposure duration may make the image captured by the camera have high brightness, and no noise will appear in the image, thereby improving the accuracy of the second exposure parameter and improving the accuracy of image capture.

In Case 2, the number of the first sensitivity is greater than 1.

When the number of the first sensitivity is greater than 1, the terminal device may determine a plurality of fourth exposure durations based on the first aperture, the plurality of first sensitivities, and the second parameter, and determine the second exposure duration from the plurality of fourth exposure durations.

In some embodiments, the fourth exposure duration may be an exposure duration associated with each first sensitivity. For example, the first sensitivity determined by the terminal device is within a range, and the terminal device may determine a plurality of first sensitivities within the range and then determine a plurality of fourth exposure durations. For example, the first sensitivity determined by the terminal device includes sensitivity 1 and sensitivity 2, and the terminal device may determine a fourth exposure duration A based on the first aperture, sensitivity 1, and the second parameter, and determine a fourth exposure duration B based on the first aperture, sensitivity 2, and the second parameter, so that the terminal device may determine the second exposure duration from the fourth exposure duration A and the fourth exposure duration B.

In some embodiments, when the fourth exposure duration satisfies a first condition, the terminal device may determine the fourth exposure duration as the second exposure duration.

Exemplarily, the value of the first sensitivity is within a range of 100 to 800, and the terminal device may determine sensitivity 1 (100), sensitivity 2 (200), sensitivity 3 (300), . . . , sensitivity 8 (800), the terminal device may determine the fourth exposure duration A based on sensitivity 1, and when the fourth exposure duration A satisfies the first condition, the terminal device may determine the fourth exposure duration A as the second exposure duration and determine that the first sensitivity is sensitivity 1, and when the fourth exposure duration does not satisfy the first condition, the terminal device may determine the fourth exposure duration B based on sensitivity 2, and when the fourth exposure duration B satisfies the first condition, the terminal device may determine the fourth exposure duration B as the second exposure duration and determine that the first sensitivity is sensitivity 2, and when the fourth exposure duration B does not satisfy the first condition, the terminal device may continue to process based on the above method until the fourth exposure duration satisfies the first condition.

Exemplarily, the value of the first sensitivity is in a range of 100 to 800, and the terminal device may determine sensitivity 1 (100), sensitivity 2 (200), sensitivity 3 (300), . . . , sensitivity 8 (800), the terminal device may determine 8 fourth exposure durations based on the 8 sensitivities, and when 4 of the fourth exposure durations satisfy the first condition, the terminal device may determine the largest fourth exposure duration as the second exposure duration, may also determine the smallest fourth exposure duration as the second exposure duration, or may determine the average exposure duration of the 4 fourth exposure durations as the second exposure duration, which is not limited in the embodiments of the present disclosure.

In some embodiments, the first condition may be less than or equal to a reciprocal of a focal length. For example, when the focal length of the camera is 200 mm, the reciprocal of the focal length is 1/200 second, that is, when the fourth exposure duration is less than or equal to 1/200 second, the terminal device may determine the fourth exposure duration as the second exposure duration, in other words, when the fourth exposure duration is longer than 1/200 second, it indicates that the duration from the opening to the closing of the shutter is greater than 1/200 second, and blurriness and jitter may occur in capturing, and when the fourth exposure duration is shorter than 1/200 second, it indicates that the duration from the opening to the closing of the shutter is less than 1/200 second, resulting in better quality of the captured image. In this way, the terminal device may accurately determine the second exposure parameter, and when the camera perform capture based on the second exposure parameter, the image will have high brightness and no noise or blurriness, thereby improving the accuracy of image capture.

In S502, determine the first aperture, the first sensitivity, and the second exposure duration as the second exposure parameter.

In some embodiments, when the number of the first sensitivity is 1, the terminal device may determine the first aperture, the first sensitivity, and the second exposure duration as the second exposure parameter. When the number of the first sensitivity is greater than 1, the terminal device may determine the sensitivity corresponding to the second exposure duration as the first sensitivity, and then determine the first aperture, the first sensitivity, and the second exposure duration as the second exposure parameter.

Exemplarily, the terminal device may determine the first sensitivity 1 and the first sensitivity 2, and the terminal device may determine the fourth exposure duration A based on the first aperture, the first sensitivity 1, and the second parameter, and determine the fourth exposure duration B based on the first aperture, the first sensitivity 2, and the second parameter. When the fourth exposure duration A satisfies the first condition, the terminal device may determine the fourth exposure duration A as the second exposure duration and determine that the first sensitivity is the first sensitivity 1. In this way, the second exposure parameter includes the first aperture, the first sensitivity 1, and the fourth exposure duration A. When the fourth exposure duration B satisfies the first condition, the terminal device may determine the fourth exposure duration B as the second exposure duration and determine that the first sensitivity is the first sensitivity 2. In this way, the second exposure parameter includes the first aperture, the first sensitivity 2, and the fourth exposure duration B.

An embodiment of the present disclosure provides a method for determining a second exposure parameter. When the number of the first sensitivity is 1, a terminal device may determine a second exposure duration based on a first aperture, the first sensitivity, and a second parameter, and when the number of the first sensitivity is greater than 1, the terminal device may determine a plurality of fourth exposure durations based on the first aperture, a plurality of first sensitivities, and the second parameter, and determine a fourth exposure duration that satisfies a first condition as the second exposure duration, and the terminal device may determine the first aperture, the first sensitivity, and the second exposure duration as the second exposure parameter. In the above method, when a camera captures images based on the second exposure parameter, the resulting image exhibit high brightness without issues of noise or blurriness. Furthermore, the terminal device does not need to analyze the image, instead, the terminal device may quickly calculate the second exposure duration based on the predetermined first aperture and first sensitivity and in combination with the second parameter. Therefore, the efficiency of determining the second exposure parameter may be improved.

Based on any of the above embodiments, a method for determining the second exposure parameter by the terminal device based on the first exposure parameter, the first parameter, and the second parameter in the above capture method is described in detail below with reference to FIG. 6.

FIG. 6 is a schematic diagram of another method for determining a second exposure parameter according to an embodiment of the present disclosure. In the embodiment shown in FIG. 6, the first parameter may be the first exposure duration. Referring to FIG. 6, the method flow includes the following steps.

In S601, determine a second sensitivity based on the first aperture in the first exposure parameter, the first exposure duration, and the second parameter.

The second sensitivity may be a sensitivity matching the camera capture mode. For example, when the first parameter is the first exposure duration, the sensitivity used by the camera when capturing an image may be the second sensitivity. For example, the terminal device has already determined the first aperture and the first exposure duration. Therefore, the terminal device may obtain the second exposure parameter after determining the second sensitivity. In other words, the first aperture and the first exposure duration are values that have been determined in the second exposure parameter, and the terminal device also needs to determine the second sensitivity in the second exposure parameter.

In some embodiments, when the camera capture mode is the second-type mode, the first parameter determined by the terminal device may be the first exposure duration. Because the terminal device may determine one first exposure duration or a plurality of first exposure durations, there are following two cases in which the terminal device determines the second sensitivity based on the first aperture, the first exposure duration, and the second parameter.

In case 1, the number of the first exposure duration is 1.

When the number of the first exposure duration is 1, the terminal device may determine the second sensitivity based on the first aperture, the first exposure duration, and the second parameter.

In some embodiments, because the number of the first exposure duration is 1, the terminal device does not need to select the first exposure duration, and the terminal device may determine the second sensitivity based on the first exposure duration, the first aperture, and the second parameter, where the second sensitivity satisfies a following formula:

$$ISO = {e}^{ln ( 100 \times A p e r t u r {e}^{2} ) - E V \times ln ( 20 ) - ln ( E xposure Time )}$$

where, in the formula, Exposure Time may be the first exposure duration, e is a natural constant, Aperture may be the first aperture, ISO may be the second sensitivity, and EV may be the second parameter.

In this way, after the terminal device determines the second sensitivity based on the above formula, the second exposure parameter composed of the first aperture, the first exposure duration, and the second sensitivity enables the image captured by the camera exhibit high brightness and no blurriness, thereby improving the accuracy of the second exposure parameter and improving the accuracy of image capture.

In case 2, the number of the first exposure duration is greater than 1.

When the number of the first exposure duration is greater than 1, the terminal device may determine a plurality of fourth sensitivities based on the first aperture, the plurality of first exposure durations, and the second parameter, and determine the second sensitivity from the plurality of fourth sensitivities.

In some embodiments, the fourth sensitivity may be a sensitivity associated with each first exposure duration. For example, the first exposure duration determined by the terminal device is a range, and the terminal device may determine a plurality of first exposure durations within the range and then determine a plurality of fourth sensitivities. For example, the first exposure duration determined by the terminal device includes exposure duration 1 and exposure duration 2, and the terminal device may determine a fourth sensitivity A based on the first aperture, exposure duration 1, and the second parameter, and determine a fourth sensitivity B based on the first aperture, exposure duration 2, and the second parameter, so that the terminal device may determine the second sensitivity from the fourth sensitivity A and the fourth sensitivity B.

In some embodiments, when the fourth sensitivity satisfies a second condition, the terminal device may determine the fourth sensitivity as the second sensitivity.

Exemplarily, the focal length of the camera is 50 mm, and the value of the first exposure duration is in a range of 1/50 second to 1/200 second. The terminal device may determine exposure duration 1 ( 1/50 second), exposure duration 2 ( 1/75 second), exposure duration 3 ( 1/100 second), . . . , exposure duration 7 ( 1/200 second). The terminal device may determine the fourth sensitivity A based on the exposure duration 1. When the fourth sensitivity A satisfies the second condition, the terminal device may determine the fourth sensitivity A as the second sensitivity and determine that the first exposure duration is exposure duration 1 ( 1/50 second). When the fourth sensitivity does not satisfy the second condition, the terminal device may determine the fourth sensitivity B based on the exposure duration 2, and when the fourth sensitivity B satisfies the second condition, the terminal device may determine the fourth sensitivity B as the second sensitivity and determine that the first exposure duration is exposure duration 2 ( 1/75 second). When the fourth sensitivity B does not satisfy the first condition, the terminal device may continue to process based on the above method until the fourth sensitivity satisfies the second condition.

Exemplarily, the focal length of the camera is 50 mm, and the value of the first exposure duration is in a range of 1/50 second to 1/200 second. The terminal device may determine the first exposure duration 1 ( 1/50 second), the first exposure duration 2 ( 1/75 second), the first exposure duration 3 ( 1/100 second), . . . , the first exposure duration 7 ( 1/200 second). The terminal device may determine 7 fourth sensitivities based on the 7 first exposure durations. When 4 of the fourth sensitivities satisfy the second condition, the terminal device may determine the largest fourth sensitivity as the second sensitivity, or determine the smallest fourth sensitivity as the second sensitivity, or determine the average sensitivity of the 4 fourth sensitivities as the second sensitivity, which is not limited in the embodiments of the present disclosure.

In some embodiments, the second condition may be 50 to 800. For example, when the fourth sensitivity is greater than or equal to 50 and the fourth sensitivity is less than or equal to 800, the terminal device may determine the fourth sensitivity as the second sensitivity. In other words, when the fourth sensitivity is within the range of 50 to 800, no noise will appear in the image captured by the camera, and the terminal device may determine the fourth sensitivity as the second sensitivity, and when the fourth sensitivity is greater than 800, noise may appear in the image captured by the camera, and when the fourth sensitivity is less than 50, the image captured by the camera will exhibit low brightness and poor quality. Therefore, the terminal device will not determine the fourth sensitivity as the second sensitivity. In this way, when the terminal device captures based on the second exposure parameter, the captured image will have high brightness without noise or blurriness, thereby improving the accuracy of image capture.

In S602, determine the first aperture, the second sensitivity, and the first exposure duration as the second exposure parameter.

In some embodiments, when the number of the first exposure duration is 1, the terminal device may determine the first aperture, the second sensitivity, and the first exposure duration as the second exposure parameter. When the number of the first exposure duration is greater than 1, the terminal device may determine the exposure duration corresponding to the second sensitivity as the first exposure duration, and then determine the first aperture, the first exposure duration, and the second sensitivity as the second exposure parameter.

Exemplarily, the terminal device may determine the first exposure duration 1 and the first exposure duration 2, and the terminal device may determine the fourth sensitivity A based on the first aperture, the first exposure duration 1, and the second parameter, and determine the fourth sensitivity B based on the first aperture, the first exposure duration 2, and the second parameter. When the fourth sensitivity A satisfies the second condition, the terminal device may determine the fourth sensitivity A as the second sensitivity and determine that the first exposure duration is the first exposure duration 1. In this way, the second exposure parameter includes: the first aperture, the first exposure duration 1, and the fourth sensitivity A. When the fourth sensitivity B satisfies the second condition, the terminal device may determine the fourth sensitivity B as the second sensitivity and determine that the first exposure duration is the first exposure duration 2. In this way, the second exposure parameter includes: the first aperture, the first exposure duration 2, and the fourth sensitivity B.

An embodiment of the present disclosure provides a method for determining a second exposure parameter. When the number of the first exposure duration is 1, a terminal device may determine the second sensitivity based on the first aperture, the first exposure duration, and the second parameter, and when the number of the first exposure duration is greater than 1, the terminal device may determine a plurality of fourth sensitivities based on the first aperture, the plurality of first exposure durations, and the second parameter, and determine a fourth sensitivity that satisfies the second condition as the second sensitivity, and the terminal device may determine the first aperture, the second sensitivity, and the first exposure duration as the second exposure parameter. In the above method, when a camera captures images based on the second exposure parameter, the image will have high brightness without noise and blurriness. Moreover, the terminal device does not need to analyze the image. Instead, the terminal device may quickly calculate the second sensitivity based on the predetermined first aperture and first exposure duration and in combination with the second parameter. Therefore, the efficiency of determining the second exposure parameter may be improved.

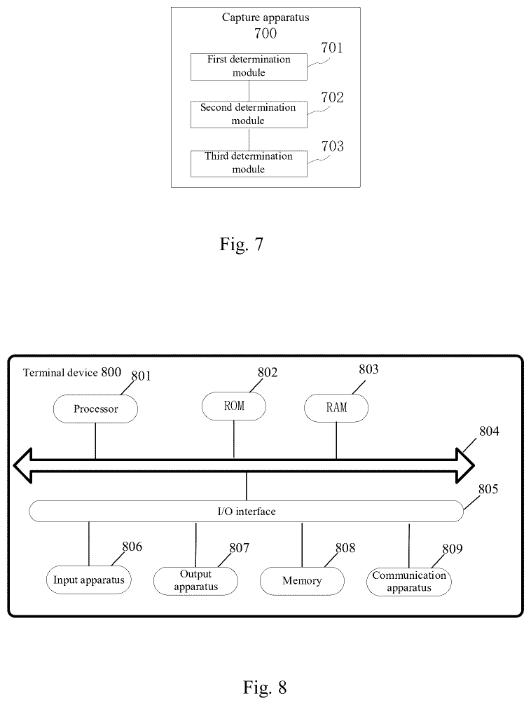

FIG. 7 is a structural schematic diagram of a capture apparatus according to an embodiment of the present disclosure. Referring to FIG. 7, the capture apparatus 700 includes a first determination module 701, a second determination module 702, and a third determination module 703.

The first determination module 701 is configured to determine a cameral capture mode in response to a touch on a first control.

The second determination module 702 is configured to determine a first exposure parameter and a first parameter of the camera based on the camera capture mode, and the first parameter is a first sensitivity or a first exposure duration.

The third determination module 703 is configured to determine a second exposure parameter of the camera based on the first exposure parameter and the first parameter, and the camera captures images based on the second exposure parameter.

In this way, the capture apparatus may determine a set of second exposure parameters for capture, and because the second exposure parameter is associated with the mode selected by the user and the current first exposure parameter of the camera, the second exposure parameter has a high degree of matching with the current capture scenario, that is, the accuracy of the second exposure parameter is relatively high. This in turn improves the accuracy of capturing by the camera. Moreover, in the above method, there is no need to manually determine a set of suitable exposure parameters based on experience, which reduces the complexity of capturing by the camera and improves the user experience. Moreover, when the capture apparatus is capturing, there is no need to analyze the current image, so that the capture apparatus may quickly determine the second exposure parameter, thereby improving the efficiency of capturing by the camera.

According to one or more embodiments of the present disclosure, the third determination module 703 is further configured to:
determine a second parameter of the camera based on the first exposure parameter, and the second parameter is used to indicate an exposure value of the camera; and
determine the second exposure parameter based on the first exposure parameter, the first parameter, and the second parameter.

Because the image brightness associated with the first exposure parameter has high accuracy, and the first parameter may avoid noise and blurriness in the image, the second exposure parameter exhibit high accuracy and good performance, the image captured by the capture apparatus have high brightness without noise or blurriness.

According to one or more embodiments of the present disclosure, the third determination module 703 is further configured to:
determine a second exposure duration based on the first aperture in the first exposure parameter, the first sensitivity, and the second parameter; and
determine the first aperture, the first sensitivity, and the second exposure duration as the second exposure parameter.

In this way, when the capture apparatus captures based on the second exposure parameter, the obtained image has relatively high brightness without noise or blurriness. Additionally, the capture apparatus does not need to analyze the image, instead, the capture apparatus may quickly calculate the second exposure duration based on the predetermined first aperture and first sensitivity and in combination with the second parameter. Therefore, the efficiency of determining the second exposure parameter may be improved.

According to one or more embodiments of the present disclosure, the third determination module 703 is further configured to:
when the number of the first sensitivity is 1, determine the second exposure duration based on the first aperture, the first sensitivity, and the second parameter; and
when the number of the first sensitivity is greater than 1, determine a plurality of fourth exposure durations based on the first aperture, a plurality of first sensitivities, and the second parameter, and determine the second exposure duration from the plurality of fourth exposure durations.

In this way, the second exposure parameter may enable the image captured by the capture apparatus have high brightness without noise, thereby improving the accuracy of the second exposure parameter and improving the accuracy of image capture.

According to one or more embodiments of the present disclosure, the third determination module 703 is further configured to:
determine a second sensitivity based on the first aperture in the first exposure parameter, the first exposure duration, and the second parameter; and
determine the first aperture, the second sensitivity, and the first exposure duration as the second exposure parameter.

In this way, when the capture apparatus captures images based on the second exposure parameter, the captured images will have high brightness without noise or blurriness. Moreover, the capture apparatus does not need to analyze the image, instead, a terminal device may quickly calculate the second sensitivity based on the predetermined first aperture and first exposure duration and in combination with the second parameter. Therefore, the efficiency of determining the second exposure parameter may be improved.

According to one or more embodiments of the present disclosure, the third determination module 703 is further configured to:
when the number of the first exposure duration is 1, determine the second sensitivity based on the first aperture, the first exposure duration, and the second parameter; and
when the number of the first exposure duration is greater than 1, determine a plurality of fourth sensitivities based on the first aperture, a plurality of first exposure durations, and the second parameter, and determine the second sensitivity from the plurality of fourth sensitivities.

In this way, the second exposure parameter may enable the image captured by the capture apparatus have high brightness without blurriness, thereby improving the accuracy of the second exposure parameter and improving the accuracy of image capture.

According to one or more embodiments of the present disclosure, the second determination module 702 is further configured to:
acquire a first aperture, a third sensitivity, and a third exposure duration associated with the camera capture mode; and
determine the first aperture, the third sensitivity, and the third exposure duration as the first exposure parameter.

In this way, the capture apparatus may determine a set of exposure parameters with relatively accurate brightness, and adjust the sensitivity or exposure duration of the camera based on the set of exposure parameters and the current scenario, so as to avoid noise and blurriness in the image, thereby improving the accuracy of capturing by the camera.

According to one or more embodiments of the present disclosure, the second determination module 702 is further configured to:
when the camera capture mode is a first-type mode, determine that the first parameter of the camera is one or more first sensitivities; and
when the camera capture mode is a second-type mode, determine that the first parameter of the camera is one or more first exposure durations.

In this way, the capture apparatus may accurately determine the first parameter based on the type of the mode, avoid noise and blurriness in the captured image, and improve the accuracy of capturing by the capture apparatus.

FIG. 8 is a structural schematic diagram of a terminal device according to an embodiment of the present disclosure. Referring to FIG. 8, it shows a schematic diagram of a structure of a terminal device 800 suitable for implementing the embodiments of the present disclosure. The terminal device may include, but is not limited to, mobile terminals such as a mobile phone, a notebook computer, a digital broadcast receiver, a personal digital assistant (abbreviated as PDA), a tablet computer, a portable media player (abbreviated as PMP), a vehicle-mounted terminal (such as a vehicle navigation terminal), etc., and fixed terminals such as a digital TV, a desktop computer, etc. The terminal device shown in FIG. 8 is only an example, and should not bring any limitation to the function and scope of use of the embodiments of the present disclosure.

As shown in FIG. 8, the terminal device 800 may include a processor (such as a central processing unit, a graphics processing unit, etc.) 801, which may perform various appropriate actions and processes based on a program stored in a read-only memory (abbreviated as ROM) 802 or a program loaded into a random access memory (abbreviated as RAM) 803 from a memory 808. In the RAM 803, various programs and data required for operations of the terminal device 800 are also stored. The processor 801, the ROM 802, and the RAM 803 are connected to each other through a bus 804. An input/output (I/O) interface 805 is also connected to the bus 804.

Usually, the following apparatuses may be connected to the I/O interface 805: an input apparatus 806 including, for example, a touch screen, a touchpad, a keyboard, a mouse, a camera, a microphone, an accelerometer, a gyroscope, etc.; an output apparatus 807 including, for example, a liquid crystal display (Liquid Crystal Display, LCD for short), a speaker, a vibrator, etc.; a memory 808 including, for example, a magnetic tape, a hard disk, etc.; and a communication apparatus 809. The communication apparatus 809 may allow the terminal device 800 to perform wireless or wired communication with other devices to exchange data. Although FIG. 8 shows the terminal device 800 having various apparatuses, it should be understood that it is not required to implement or have all of the shown apparatuses. More or fewer apparatuses may be implemented or provided alternatively.

In particular, according to the embodiments of the present disclosure, the process described above with reference to the flowchart may be implemented as a computer software program. For example, the embodiments of the present disclosure include a computer program product, which includes a computer program carried on a computer-readable medium, where the computer program includes program codes for performing the method shown in the flowchart. In such an embodiment, the computer program may be downloaded and installed from a network through the communication apparatus 809, or installed from the memory 808, or installed from the ROM 802. When the computer program is executed by the processor 801, the above-mentioned functions defined in the method of the embodiments of the present disclosure are executed.

It should be noted that the above-mentioned computer-readable medium in the present disclosure may be a computer-readable signal medium, a computer-readable storage medium, or any combination of the two. The computer-readable storage medium may be, for example, but not limited to, an electronic, magnetic, optical, electromagnetic, infrared, or semiconductor system, apparatus or device, or any combination of the above. More specific examples of the computer-readable storage medium may include, but are not limited to: an electrically connected portable computer disk with one or more wires, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus or device. In the present disclosure, the computer-readable signal medium may include a data signal propagated in a baseband or as a part of a carrier wave, and computer-readable program codes are carried in the data signal. The data signal propagated in this way may be in multiple forms, including but not limited to an electromagnetic signal, an optical signal, or any suitable combination of the above. The computer-readable signal medium may also be any computer-readable medium other than the computer-readable storage medium, and the computer-readable signal medium may send, propagate or transmit the program used by or in combination with the instruction execution system, apparatus or device. The program codes contained on the computer-readable medium may be transmitted in any suitable medium, including but not limited to: a wire, an optical cable, RF (radio frequency), etc., or any suitable combination of the above.

The above-mentioned computer-readable medium may be contained in the above-mentioned terminal device, or may exist alone without being assembled into the terminal device.

The above-mentioned computer-readable medium carries one or more programs, and when the above-mentioned one or more programs are executed by the terminal device, the terminal device is caused to execute the method shown in the above-mentioned embodiments.

An embodiment of the present disclosure provides a computer-readable storage medium, where a computer-executed instruction is stored in the computer-readable storage medium, and when the computer-executed instruction is executed by a processor, the method according to various possible involvements of the above embodiments is implemented.

An embodiment of the present disclosure provides a computer program product, including a computer program, where when the computer program is executed by a processor, the method according to various possible involvements of the above embodiments is implemented.

According to one or more embodiments of the present disclosure, the embodiments of the present disclosure provide a terminal device, a computer-readable storage medium, and a computer program product. The terminal device may determine a set of second exposure parameters for capturing, and because the second exposure parameter is associated with the mode selected by the user and the current first exposure parameter of the camera, the second exposure parameter has a high degree of matching with the current capture scenario, that is, the accuracy of the second exposure parameter is high, thereby improving the accuracy of capturing by the camera. Moreover, in the above method, there is no need to manually determine a set of suitable exposure parameters based on experience, which reduces the complexity of capturing by the camera and improves the user experience. Moreover, when the terminal device is capturing, there is no need to analyze the current image, so that the terminal device may quickly determine the second exposure parameter, thereby improving the efficiency of capturing by the camera.

The computer program codes for performing the operations of the present disclosure may be written in one or more programming languages or a combination thereof, where the programming languages include object-oriented programming languages such as Java, Smalltalk, C++, and also include conventional procedural programming languages such as “C” language or similar programming languages. The program codes may be executed entirely on a user computer, partly on the user computer, executed as an independent software package, partly on the user computer and partly on a remote computer, or entirely on the remote computer or server. In the case of involving the remote computer, the remote computer may be connected to the user computer through any kind of network, including a local area network (abbreviated as LAN) or a wide area network (abbreviated as WAN), or may be connected to an external computer (for example, connected through the Internet using an Internet service provider).

The flowcharts and block diagrams in the drawings illustrate the architecture, functionality, and operation of possible implementations of systems, methods and computer program products according to various embodiments of the present disclosure. In this regard, each block in the flowchart or block diagrams may represent a module, a program segment, or a portion of code that includes one or more executable instructions for implementing a specified logical function. Furthermore, it should be noted that, in some alternative implementations, functions indicated in the blocks may occur in an order different from that indicated in the drawings. For example, two blocks shown in succession may, in fact, be executed substantially concurrently, or the blocks may sometimes be executed in the reverse order, depending upon the functionality involved. It also should be noted that each block of the block diagrams and/or flowcharts, or a combination of blocks in the block diagrams and/or flowcharts may be implemented in a special purpose hardware-based system that perform a specified function or operation, or may be implemented in a combination of special purpose hardware and a computer instruction.

The involved units described in the embodiments of the present disclosure may be implemented by means of software, and may also be implemented by means of hardware. The name of a unit does not constitute a limitation on the unit itself under certain circumstances, for example, the first acquiring unit may also be described as “a unit for acquiring at least two internet protocol addresses”.

The foregoing functions described herein may be performed at least in part by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD) and the like.

In the context of the present disclosure, a machine-readable medium may be a tangible medium that may contain or store a program for use by or in combination with an instruction execution system, apparatus or device. The machine-readable medium may be a machine-readable signal medium or a machine-readable storage medium. The machine-readable medium includes, but is not limited to, an electronic, magnetic, optical, electromagnetic, infrared, or semi-conductive system, apparatus or device, or any suitable combination of the foregoing. More specific examples of the machine-readable storage medium would include an electrical connection on the basis of one or more wires, a portable computer disk, a hard disk, a random access memory (RAM), a read only memory (ROM), an erasable programmable read only memory (EPROM or a flash memory), an optical fiber, a portable compact disk read-only memory (CD-ROM), an optical storage device, a magnetic storage device, or any suitable combination of the foregoing.

It should be noted that the modifiers of “one” and “multiple” mentioned in the present disclosure are illustrative and not restrictive, and those skilled in the art should understand that unless otherwise explicitly indicated in the context, they should be understood as “one or more”.

The names of messages or information exchanged between multiple apparatuses in the implementations of the present disclosure are only used for illustrative purposes, and are not used to limit the scope of these messages or information.

It may be understood that the data involved in the technical solution (including but not limited to the data itself, acquisition or use of the data) should comply with requirements of corresponding laws, regulations and related provisions. The data may include information, parameters, messages, etc., such as the stream switching indication information.

The above description is only a preferred embodiment of the present disclosure and an illustration of the applied technical principles. Those skilled in the art should understand that the scope of disclosure involved in the present disclosure is not limited to the technical solutions formed by the specific combination of the above technical features, and should also cover other technical solutions formed by any combination of the above technical features or their equivalent features without departing from the above disclosed concept. For example, the above features and the technical features provided in the present disclosure (but not limited to) with similar functions may be replaced each other to form a technical solution.

In addition, although the various operations are depicted in a specific order, this should not be understood as requiring the operations to be performed in the specific order shown or in a sequential order. Under certain circumstances, multitasking and parallel processing may be advantageous. Similarly, although the above discussion contains a number of specific implementation details, these should not be interpreted as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination. Although the subject matter has been described in a language specific to structural features and/or logical actions of the method, it should be understood that the subject matter defined in the appended claims is not necessarily limited to the specific features or actions described above. On the contrary, the specific features and actions described above are only exemplary forms of implementing the claims

1. A capture method, comprising:
determining a camera capture mode in response to a touch on a first control;
determining a first exposure parameter and a first parameter of the camera based on the camera capture mode, the first parameter being a first sensitivity or a first exposure duration; and
determining a second exposure parameter of the camera based on the first exposure parameter and the first parameter, the camera performing capture based on the second exposure parameter.

2. The capture method of claim 1, wherein the determining a second exposure parameter of the camera based on the first exposure parameter and the first parameter, comprises:
determining a second parameter of the camera based on the first exposure parameter, the second parameter being configured to indicate an exposure value of the camera; and
determining the second exposure parameter based on the first exposure parameter, the first parameter, and the second parameter.

3. The capture method of claim 2, wherein in response to the first parameter being the first sensitivity, the determining the second exposure parameter based on the first exposure parameter, the first parameter, and the second parameter, comprises:
determining a second exposure duration based on a first aperture in the first exposure parameter, the first sensitivity, and the second parameter; and
determining the first aperture, the first sensitivity, and the second exposure duration as the second exposure parameter.

4. The capture method of claim 3, wherein the determining a second exposure duration based on a first aperture in the first exposure parameter, the first sensitivity, and the second parameter, comprises:
in response to a number of the first sensitivity being one, determining the second exposure duration based on the first aperture, the first sensitivity, and the second parameter; and
in response to the number of the first sensitivity being greater than one, determining a plurality of fourth exposure durations based on the first aperture, a plurality of first sensitivities, and the second parameter, and determining the second exposure duration from the plurality of fourth exposure durations.

5. The capture method of claim 2, wherein in response to the first parameter being the first exposure duration, the determining the second exposure parameter based on the first exposure parameter, the first parameter, and the second parameter, comprises:
determining a second sensitivity based on a first aperture in the first exposure parameter, the first exposure duration, and the second parameter; and
determining the first aperture, the second sensitivity, and the first exposure duration as the second exposure parameter.

6. The capture method of claim 5, wherein the determining a second sensitivity based on a first aperture in the first exposure parameter, the first exposure duration, and the second parameter, comprises:
in response to a number of the first exposure duration being one, determining the second sensitivity based on the first aperture, the first exposure duration, and the second parameter; and
in response to the number of the first exposure duration being greater than one, determining a plurality of fourth sensitivities based on the first aperture, a plurality of first exposure durations, and the second parameter, and determining the second sensitivity from the plurality of fourth sensitivities.

7. The capture method of claim 1, wherein the determining a first exposure parameter of the camera based on the camera capture mode, comprises:
acquiring a first aperture, a third sensitivity, and a third exposure duration associated with the camera capture mode; and
determining the first aperture, the third sensitivity, and the third exposure duration as the first exposure parameter.

8. The capture method of claim 2, wherein the camera capture mode comprises a first-type mode and a second-type mode, and the determining a first parameter of the camera based on the camera capture mode, comprises:
in response to the camera capture mode being the first-type mode, determining that the first parameter of the camera is one or more first sensitivities; and
in response to the camera capture mode being the second-type mode, determining that the first parameter of the camera is one or more first exposure durations.

9. The capture method of claim 2, wherein the determining a first exposure parameter of the camera based on the camera capture mode, comprises:
acquiring a first aperture, a third sensitivity, and a third exposure duration associated with the camera capture mode; and
determining the first aperture, the third sensitivity, and the third exposure duration as the first exposure parameter.

10. The capture method of claim 3, wherein the determining a first exposure parameter of the camera based on the camera capture mode, comprises:
acquiring a first aperture, a third sensitivity, and a third exposure duration associated with the camera capture mode; and
determining the first aperture, the third sensitivity, and the third exposure duration as the first exposure parameter.

11. The capture method of claim 5, wherein the camera capture mode comprises a first-type mode and a second-type mode, and the determining a first parameter of the camera based on the camera capture mode, comprises:
in response to the camera capture mode being the first-type mode, determining that the first parameter of the camera is one or more first sensitivities; and
in response to the camera capture mode being the second-type mode, determining that the first parameter of the camera is one or more first exposure durations.

12. The capture method of claim 6, wherein the camera capture mode comprises a first-type mode and a second-type mode, and the determining a first parameter of the camera based on the camera capture mode, comprises:
in response to the camera capture mode being the first-type mode, determining that the first parameter of the camera is one or more first sensitivities; and
in response to the camera capture mode being the second-type mode, determining that the first parameter of the camera is one or more first exposure durations.

13. A terminal device, comprising:
at least a processor; and
a memory,
wherein the memory stores a computer-executed instruction,
wherein the processor executes the computer-executed instruction stored in the memory, so as to cause the processor to execute a capture method, and
wherein the capture method comprises:
determining a camera capture mode in response to a touch on a first control;
determining a first exposure parameter and a first parameter of the camera based on the camera capture mode, the first parameter being a first sensitivity or a first exposure duration; and
determining a second exposure parameter of the camera based on the first exposure parameter and the first parameter, the camera performing capture based on the second exposure parameter.

14. The terminal device of claim 13, wherein the determining a second exposure parameter of the camera based on the first exposure parameter and the first parameter, comprises:
determining a second parameter of the camera based on the first exposure parameter, the second parameter being configured to indicate an exposure value of the camera; and
determining the second exposure parameter based on the first exposure parameter, the first parameter, and the second parameter.

15. The terminal device of claim 14, wherein in response to the first parameter being the first sensitivity, the determining the second exposure parameter based on the first exposure parameter, the first parameter, and the second parameter, comprises:
determining a second exposure duration based on a first aperture in the first exposure parameter, the first sensitivity, and the second parameter; and
determining the first aperture, the first sensitivity, and the second exposure duration as the second exposure parameter.

16. The terminal device of claim 15, wherein the determining a second exposure duration based on a first aperture in the first exposure parameter, the first sensitivity, and the second parameter, comprises:
in response to a number of the first sensitivity being one, determining the second exposure duration based on the first aperture, the first sensitivity, and the second parameter; and
in response to the number of the first sensitivity being greater than one, determining a plurality of fourth exposure durations based on the first aperture, a plurality of first sensitivities, and the second parameter, and determining the second exposure duration from the plurality of fourth exposure durations.

17. The terminal device of claim 14, wherein in response to the first parameter being the first exposure duration, the determining the second exposure parameter based on the first exposure parameter, the first parameter, and the second parameter, comprises:
determining a second sensitivity based on a first aperture in the first exposure parameter, the first exposure duration, and the second parameter; and
determining the first aperture, the second sensitivity, and the first exposure duration as the second exposure parameter.

18. The terminal device of claim 17, wherein the determining a second sensitivity based on a first aperture in the first exposure parameter, the first exposure duration, and the second parameter, comprises:
in response to a number of the first exposure duration being one, determining the second sensitivity based on the first aperture, the first exposure duration, and the second parameter; and
in response to the number of the first exposure duration being greater than one, determining a plurality of fourth sensitivities based on the first aperture, a plurality of first exposure durations, and the second parameter, and determining the second sensitivity from the plurality of fourth sensitivities.

19. The terminal device of claim 13, wherein the determining a first exposure parameter of the camera based on the camera capture mode, comprises:
acquiring a first aperture, a third sensitivity, and a third exposure duration associated with the camera capture mode; and
determining the first aperture, the third sensitivity, and the third exposure duration as the first exposure parameter.

20. A non-transitory computer-readable storage medium, wherein a computer-executed instruction is stored in the computer-readable storage medium, and when the computer-executed instruction is executed by a processor, a capture method is implemented, and
wherein the capture method comprises:
determining a camera capture mode in response to a touch on a first control;
determining a first exposure parameter and a first parameter of the camera based on the camera capture mode, the first parameter being a first sensitivity or a first exposure duration; and
determining a second exposure parameter of the camera based on the first exposure parameter and the first parameter, the camera performing capture based on the second exposure parameter.
